(19) United States
(12) Patent Application Publication
(10) Pub. No.: US 2025/0335284 A1
(43) Pub. Date: Oct. 30, 2025

(54) MEMORY SYSTEM POWER MANAGEMENT INTEGRATED CIRCUITRY MONITORING

(71) Applicant: Micron Technology, Inc., Boise, ID (US)

(72) Inventors: Da Hong, Hangzhou (CN); Ke Xian Huang, Shenzhen (CN); Qing Xu, Shenzhen (CN)

(21) Appl. No.: 19/175,372

(22) Filed: Apr. 10, 2025

Related U.S. Application Data
(60) Provisional application No. 63/639,483, filed on Apr. 26, 2024.

(51) Int. Cl. G06F 11/07; G06F 1/20

(52) U.S. Cl. CPC G06F 11/0772; G06F 1/206; G06F 11/0787; G06F 11/0793

(57) ABSTRACT

Methods, systems, and devices for memory system power management integrated circuitry monitoring are described. A system management controller may poll registers of a power integrated management circuit (PMIC) of a memory system in response to receiving an indication of a failure at the PMIC that may trigger a shutdown condition of the memory system. For example, despite the memory system being in a shutdown condition, power to the registers of the PMIC may remain enabled, and values from the PMIC register may be polled and stored by the system management controller. The values from the PMIC register may indicate a location of the failure of the PMIC or one or more operating parameters of the PMIC during the point of failure. The system management controller may output the stored values from the PMIC registers, which may support identification of root causes of failure at the PMIC.

### CROSS REFERENCE

The present Application for Patent claims priority to U.S. Patent Application No. 63/639,483 by Hong et al., entitled “MEMORY SYSTEM POWER MANAGEMENT INTEGRATED CIRCUITRY MONITORING,” filed Apr. 26, 2024, which is assigned to the assignee hereof, and which is expressly incorporated by reference in its entirety herein.

### TECHNICAL FIELD

The following relates to one or more systems for memory, including memory system power management integrated circuitry monitoring.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports memory system power management integrated circuitry monitoring in accordance with examples as disclosed herein.

FIG. 2 shows an example of a system that supports memory system power management integrated circuitry monitoring in accordance with examples as disclosed herein.

FIG. 3 shows a block diagram of a system management controller that supports memory system power management integrated circuitry monitoring in accordance with examples as disclosed herein.

FIGS. 4 and 5 show flowcharts illustrating methods that support memory system power management integrated circuitry monitoring in accordance with examples as disclosed herein.

### DETAILED DESCRIPTION

In some memory systems, a power management integrated circuit (PMIC) may regulate power (e.g., in accordance with a regulated voltage) for one or more components of the memory system. A PMIC may include one or more registers that store operating parameters (e.g., temperature, power, voltage, current) of the PMIC or one or more components managed by the PMIC. In some examples, a PMIC may output an indication of a failure at the PMIC, which may cause a memory system to enter a shutdown condition (e.g., a shutdown mode). A system management controller (e.g., a baseboard management controller (BMC)) may receive the output from the PMIC and may log the failure of the PMIC. However, the system management controller may receive and store a limited set of information about the failure. Accordingly, a root cause of the failure may be difficult to identify (e.g., during failure analysis of the memory system).

In accordance with examples as disclosed herein, a system management controller may be configured to poll one or more registers of a PMIC in response to receiving an indication of a failure at the PMIC. For example, despite a memory system being in a shutdown condition, power to registers of a PMIC may remain enabled (e.g., may be available), and values from the PMIC register may be recovered (e.g., polled) and stored by the system management controller. The values from the PMIC register may indicate a location of the failure of the PMIC, one or more operating parameters (e.g., temperature, voltage, current) of the PMIC or of power interfaces (e.g., power rails) coupled with the PMIC during the failure, or any combination thereof. The system management controller may output the stored values from the PMIC registers, which may support (e.g., improve) identification of root causes of failure at the PMIC. Additionally, or alternatively, a system management controller may poll one or more registers of a PMIC during runtime, and may support performing operations in accordance with various failure mitigation policies or procedures. For example, based on a value of a PMIC register satisfying criteria (e.g., a threshold), the system management controller may perform one or more failure mitigation operations to prevent failures at the PMIC. The one or more failure mitigation operations may include increasing a speed of a fan, throttling a host processing system, throttling a memory bus, signaling one or more warning indications, or migrating one or more operations of the host processing system. By initiating failure mitigation procedures in accordance with a PMIC register value, the system management controller may mitigate failures at the PMIC and improve recovery of services prior to shutdown of memory systems or host processing systems.

In addition to applicability in memory systems as described herein, techniques for memory system power management integrated circuitry monitoring may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by improving root cause analysis for evaluating failure conditions of a PMIC, as well as reducing product failures by performing proactive failure mitigation measures in response to PMIC operating conditions, which may extend the life of electronic devices and thereby reduce electronic waste, among other benefits.

Features of the disclosure are illustrated and described in the context of systems. Features of the disclosure are further illustrated and described in the context of systems and flowcharts.

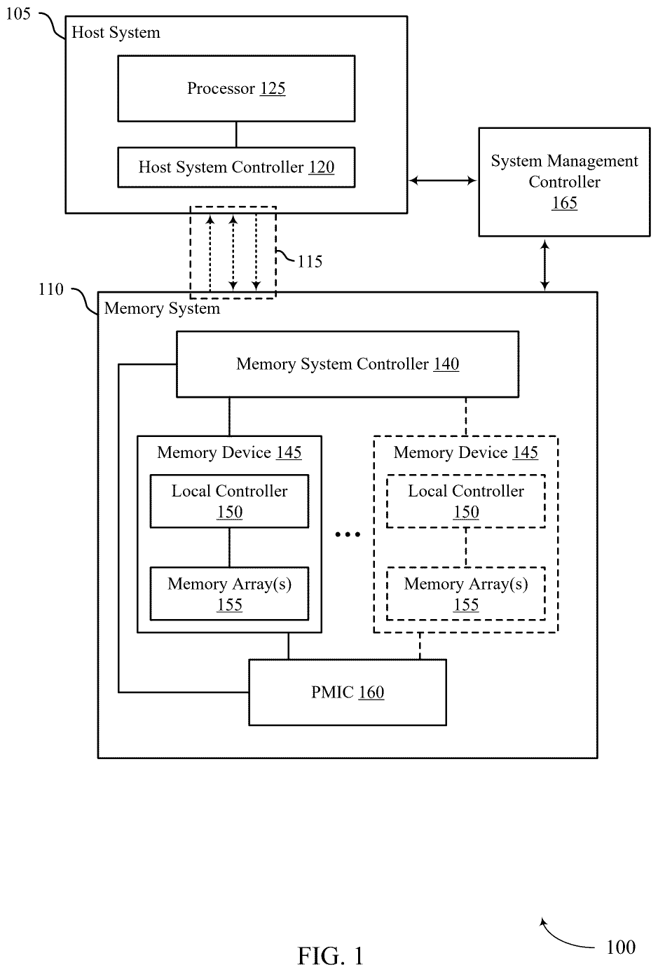

FIG. 1 illustrates an example of a system 100 that supports memory system power management integrated circuitry monitoring in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, a processor 125, or a PMIC 160. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

The memory system 110 also includes a PMIC 160, which may monitor and manage power (e.g., in accordance with one or more controlled voltage outputs) for one or more operations at the memory system 110. For example, the PMIC 160 may perform voltage scaling (e.g., upscaling, downscaling) of a source voltage (e.g., using DC-to-DC conversion) to regulate and provide power to one or more components of the memory system 110 (e.g., one or more memory devices 145, a registered clock driver (RCD), or a serial presence detect (SPD) hub, among other). In some examples, the PMIC 160 may include one or more registers that store (e.g., record) one or more operating parameters of the PMIC 160 or of one or more source voltages (e.g., power interfaces to the memory system 110). Such recorded operating parameters may include information related to temperature values, voltage values, current values, or power values, or thresholds thereof, among other parameters.

The system 100 may also include a system management controller 165, which may include at least one of one or more components (e.g., circuitry, logic, instructions) operable to control operations of the memory system 110, the host system 105, or both. A system management controller 165 may also be referred to as or be an example of a baseboard management controller (BMC). In some examples, a system management controller 165 may remotely monitor and manage one or more aspects of a host system 105. For example, a system management controller 165 may be configured to measure (e.g., using one or more sensors) physical parameters of the host system 105 such as temperature values, power supply voltages, fan speeds, or communication parameters, among other examples. In some examples, a system management controller 165 may create or store event logs for failure analysis.

In some examples, a PMIC 160 may regulate power (e.g., voltage) for one or more components of a memory system 110. The PMIC 160 may include one or more registers that store operating parameters (e.g., temperature, power, voltage, current) of the PMIC 160 or one or more components managed by the PMIC. In some examples, the PMIC 160 may output an indication of a failure at the PMIC 160, which may cause a memory system to enter a shutdown condition (e.g., a shutdown mode). A system management controller 165 (e.g., a baseboard management controller (BMC)) may receive the output from the PMIC 160 and may log the failure of the PMIC 160. However, the system management controller 165 may receive and store a limited set of information about the failure. Accordingly, a root cause of the failure may be difficult to identify (e.g., during failure analysis of the memory system).

In accordance with examples as disclosed herein, a system management controller 165 may be configured to poll one or more registers of the PMIC 160 in response to receiving an indication of a failure at the PMIC 160. For example, despite the memory system 110 being in a shutdown condition, power to registers of a PMIC 160 may remain enabled (e.g., may be available), and values from the registers of the PMIC 160 may be recovered (e.g., polled) and stored by the system management controller 165. The values from the registers of the PMIC 160 may indicate a location of the failure of the PMIC 160, one or more operating parameters (e.g., temperature, voltage, current) of the PMIC 160 or of power interfaces (e.g., power rails) coupled with the PMIC 160 during the failure, or any combination thereof. The system management controller 165 may output the stored values from the registers of the PMIC 160, which may support (e.g., improve) identification of root causes of failure at the PMIC 160.

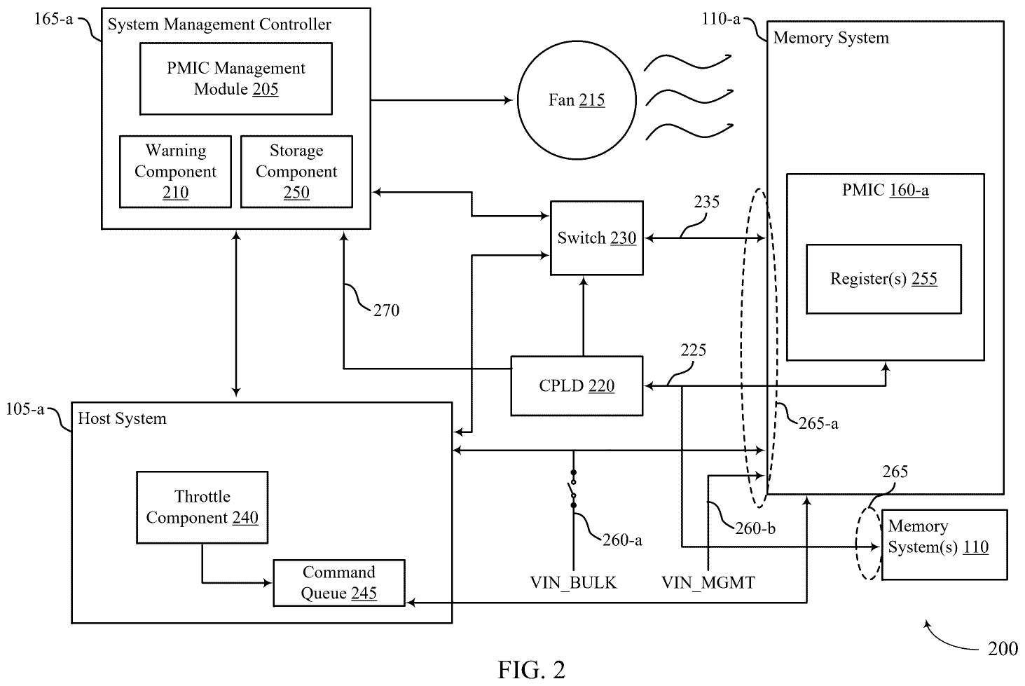

FIG. 2 shows an example of an architecture 200 that supports memory system power management integrated circuitry monitoring in accordance with examples as disclosed herein. The architecture 200 may implement or may be implemented by aspects of a system 100. For example, the architecture 200 may include a host system 105-a, a memory system 110-a, a PMIC 160-a, and a system management controller 165-a. In some examples, the architecture 200 may include a dual in-line memory module (DIMM) slot 265-a (e.g., a DIMM connector), which may support an interface between the memory system 110-a and other components of the architecture 200. In some examples, the memory system 110-a may be referred to as being located at the DIMM slot 265-a. Additionally, or alternatively, the architecture 200 may include one or more other DIMM slots 265 (e.g., any quantity of DIMM slots 265), which may support an interface between one or more other memory systems 110 and other components of the architecture 200. In some examples, a location of each memory system 110 (e.g., the memory system 110-a, the memory system(s) 110), or a PMIC 160 thereof, may be identifiable based on the DIMM slot 265 the memory system 110 is connected to.

The PMIC 160-a may include one or more registers 255, which may be configured to store information pertaining to errors or failures at the PMIC 160-a, among other information. For example, the register(s) 255 may be configured to indicate whether one or more outputs of the PMIC 160-a are over or under a voltage threshold, or over or under a current threshold. Additionally, or alternatively, the register(s) 255 may be configured to indicate whether a temperature of the PMIC 160-a is above a threshold temperature (e.g., indicating high temperature warning, indicating critical temperature). Additionally, or alternatively, the register(s) 255 may be configured to indicate whether power rails (e.g., VIN_Bulk, VIN_Mgmt, voltage outputs) coupled with the memory system 110-a are over a voltage threshold. In some examples, a control and monitor port (CAMP) 225 (e.g., a port of the PMIC 160-a, a port of the memory system 110-a, a terminal of a DIMM slot 265-a) may trigger an output that indicates for the memory system 110-a, the host system 105-a, or a combination thereof, to enter a shutdown condition (e.g., a CPU shutdown, a shutdown mode). In some examples, the output may indicate a failure of the PMIC 160-a.

In some examples, the register(s) 255 of the PMIC 160-a may be accessed via an interface 235, which may be or include an inter-integrated circuit (I2C) interface or an improved inter-integrated circuit (I3C) interface, among other examples. In some examples, a complex programmable logic device (CPLD) 220 may control a switch 230 (e.g., a multiplexer (MUX)), which may selectively couple the interface 235 with one of the host system 105-a or the system management controller 165-a. During boot time (e.g., initialization) of the host system 105-a, the interface 235 may be coupled with the host system 105-a (e.g., via the switch 230). The host system 105-a may poll the register(s) 255 of the PMIC 160-a and may disable one or more dual-in-line memory module (DIMM) slots of the architecture 200 that have errors based on the polling. In some examples, the host system 105-a may transmit values of the register(s) 255 of the PMIC 160-a to the system management controller 165-a, or to one or more operating systems, or transmit indications to a user (e.g., via an output device).

During runtime (e.g., operations, application operations) of the host system 105-a, the interface 235 may be coupled with the system management controller 165-a. The system management controller 165-a may poll the register(s) 255 of the PMIC 160-a, which may indicate one or more values associated with one or more output terminals (e.g., output rails, regulated voltage outputs) of the PMIC 160-a. In some cases, the CPLD 220 may transmit, to the system management controller 165-a, an indication of a failure of the PMIC 160-a. For example, a failure of the PMIC 160-a may be associated with a CAMP 225 indicating (e.g., triggering, via host system 105-a) a shutdown condition of the memory system 110-a. In some cases, the CPLD 220 may transmit the indication of the failure of the PMIC 160-a via a general-purpose input/output (GPIO) interface 270 (e.g., a GPIO interrupt), which may trigger an interrupt at the system management controller 165-a. The system management controller 165-a may store (e.g., in a log, in a storage component 250) the failure of the PMIC 160-a. However, some information that the system management controller 165-a stores regarding the failure of the PMIC 160-a may not identify a DIMM slot or particular memory system 110 associated with the failure.

For example, the CAMP 225 may be coupled (e.g., with the CPLD 220) in parallel with a set of multiple memory systems 110 via multiple DIMM slots 265, and a failure associated with at least one DIMM slot 265 (e.g., at least one memory system 110, or PMIC 160 thereof) of the set of multiple DIMM slots 265 may trigger the CAMP 225 to output a failure to the CPLD 220. Thus, the CPLD 220 may receive an indication of a failure at the PMIC 160-a via the CAMP 225, but the indication may lack sufficient information for the CPLD to identify the PMIC 160-a having the failure (e.g., lacking sufficient information to identify the memory system 110-a, lacking sufficient information to identify the DIMM slot 265-a through which the memory system 110-a is coupled). In other words, the CPLD 220 may be unable to determine a location of the failure among multiple memory systems 110 or multiple DIMM slots 265 based on the output received via the CAMP 225. The CPLD 220 may forward the output to the system management controller 165-a, and the system management controller 165-a may store the output in a log, but the stored output may not identify the PMIC 160-a as having experienced the failure.

In some examples, the memory system 110-a may be coupled with multiple voltage sources 260 (e.g., power rails) which may provide power for one or more operations of the memory system 110-a. A voltage source 260-a (e.g., VIN_BULK) may correspond to a relatively greater voltage than a voltage source 260-b (e.g., VIN_MGMT). In response to a failure condition (e.g., of the PMIC 160-a), the memory system 110-a may enter a shutdown condition. During the shutdown condition of the memory system 110-a (e.g., after the failure at the PMIC 160-a), the voltage source 260-a may be disabled (e.g., decoupled, disconnected from the memory system 110-a), while the voltage source 260-b remains enabled. Because the voltage source 260-b may remain enabled after the failure, the register(s) 255 may be accessible (e.g., may retain information, may be available for polling) after the failure.

In accordance with examples described herein, the system management controller 165-a may poll register(s) 255 (e.g., via the interface 235) in response to receiving an indication of a failure of the PMIC 160-a. For example, the system management controller 165-a may poll the register(s) 255 based on receiving the output on the CAMP 225 via the CPLD 220. The CAMP 225 may indicate a failure at the PMIC 160-a, may indicate that the memory system 110-a or the host system 105-a is entering a shutdown condition, or a combination thereof. In some examples, the polled register(s) 255 may indicate a location of the failure at the PMIC 160-a (e.g., a location or identifier of the memory system 110-a, a location or identifier of the DIMM slot 265-a). In some examples, the system management controller 165-a may poll each of the register(s) 255 of the PMIC 160-a and may identify the location of the failure at the PMIC 160-a based on polling the register(s) 255. For example, the system management controller 165-a may poll a set of values, and each value of the set of values may correspond to a respective DIMM slot 265 of a set of DIMM slots 265. Additionally, or alternatively, the indication of the failure (e.g., output of the CAMP 225) may indicate a subset of DIMM slots 265 corresponding to the failure at the PMIC 160-a, and the system management controller 165-a may poll a set of values corresponding to the subset of DIMM slots 265.

The system management controller 165-a may store values corresponding to DIMM slots 265 (e.g., for each DIMM slot associated with the register(s) 255, for the subset of DIMM slots 265, for DIMM slots 265 identified by the system management controller 165-a as being associated with the failure) at a storage component 250. The values stored at the storage component 250 may be indicated to a user to identify which of the memory systems 110 (e.g., the memory system 110-a) includes a PMIC 160 that experienced a failure (e.g., to replace the memory system 110-a, to service the memory system 110-a, to support a root cause analysis of failure of the PMIC 160-a).

Additionally, or alternatively, a system management controller 165-a may be configured to poll the register(s) 255, such as polling indications of operating parameters of one or more power interfaces associated with the PMIC 160-a. For example, the register(s) 255 may indicate operating parameters of the voltage sources 260-a and 260-b (e.g., VIN_BULK, VIN_MGMT) or one or more power output terminals of the PMIC 160-a. Additionally, or alternatively, the system management controller 165-a may poll register(s) 255 for indications of operating parameters of the PMIC 160-a. For example, the operating parameters may indicate an over-voltage condition or an under-voltage condition associated with the PMIC 160-a, an over-current condition or an under-current condition associated with the PMIC 160-a, temperature values (e.g., measurements) of the PMIC 160-a, or a combination thereof.

In some examples, the system management controller 165-a may poll register(s) 255 during operations of the host system 105-a (e.g., during CPU runtime). The system management controller 165-a may poll the register(s) 255 in accordance with a periodic interval during operations of the host system 105-a, the memory system 110-a, or both. Based on the polling, the system management controller 165-a may receive an indication of one or more values of the register(s) 255 that indicate operating parameters of the PMIC 160-a.

In some examples, the system management controller 165-a may perform mitigation operations (e.g., failure mitigation operations, temperature mitigation operations) to reduce a thermal characteristic (e.g., temperature, heating, current) of the PMIC 160-a, to signal a warning of a circuit defect (e.g., a crack, a short, an electrical discontinuity), or to migrate (e.g., from the host system 105-a to another host system 105, from the memory system 110-a to another memory system 110, from the DIMM slot 265-a to another DIMM slot 265) operations between the host system 105-a and the memory system 110-a, among other operations. The system management controller 165-a may perform failure mitigation operations based on one or more operating parameters of the PMIC 160-a satisfying criteria (e.g., thresholds). In some examples, the failure mitigation operations, or the criteria, or a combination thereof may be based on a failure mitigation policy that is configured at a PMIC management module 205 of the system management controller 165-a. In some examples, the system management controller 165-a may update failure mitigation operations, thresholds, or a combination thereof. Additionally, or alternatively, the system management controller 165-a may activate some failure mitigation operations (e.g., and corresponding thresholds) of the failure mitigation policy, while deactivating other failure mitigation operations (e.g., based on the memory system 110 that the failure mitigation policy applies to, based on operating parameters of the memory system 110, based on historical results associated with memory system(s) 110, based on other parameters).

In an illustrative example, the system management controller 165-a may poll the register(s) 255 and determine that a temperature value of the PMIC 160-a satisfies a temperature threshold (e.g., is above a threshold, is a relatively high temperature). In response to the temperature value satisfying the threshold, the system management controller 165-a may increase a speed of a fan 215 that is coupled with the system management controller 165-a, which may reduce a temperature of the memory system 110-a, the PMIC 160-a, or both. In some examples, system management controller 165-a may increase the speed of the fan 215 until the temperature at the PMIC falls below a threshold (e.g., a same threshold used to increase the speed of the fan 215, a different threshold than one used to increase the speed of the fan 215).

In another illustrative example, the system management controller 165-a may poll the register(s) 255 and determine that a current or a power associated with the PMIC 160-a satisfies a threshold (e.g., is above a threshold, is a relatively high current or power). In response to the current or power satisfying the threshold, the system management controller 165-a may output, to the host system 105-a, an indication to perform a throttling operation. The indication to perform the throttling operation may be indicated to the host system 105-a via a sideband interface between the system management controller 165-a and the host system 105-a. Based on the indication to perform the throttling operation, a throttle component 240 (e.g., throttle engine) of the host system 105-a may throttle one or more operations at the memory system 110-a (e.g., reduce a rate of operations, reduce a quantity of operations, reduce a degree of parallelism, reduce a clock speed, throttle a memory bus). The throttled operations may be indicated via one or more commands transmitted to the memory system 110-a (e.g., via a command queue 245). In some examples, the host system 105-a may reduce a quantity of activate (ACT) or column address strobe (CAS) commands at the command queue 245 to below a threshold based on performing the throttling. By performing the throttling operation, the host system 105-a may reduce power consumption, heat generation, or both at the memory system 110-a, which may prevent a voltage regulator at the PMIC 160-a from being disabled or reduce a likelihood of failure at the PMIC 160-a.

In another illustrative example, the system management controller 165-a may poll the register(s) 255 and determine that a current associated with the PMIC 160-a satisfies a threshold. In some examples, the system management controller 165-a may also determine that performance data associated with the PMIC 160-a is unaffected. In response to the current satisfying the threshold, the system management controller 165-a may signal a warning, via the warning component 210. In some examples, the warning component 210 may be a visual indicator, such as a display or a light emitting diode (LED). The warning component 210 may indicate to a user of the memory system 110-a that a circuit at the PMIC 160-a may have a defect (e.g., a crack, a short) and may indicate to perform an evaluation of one or more circuit components. In some other examples, in response to the current satisfying the threshold, the system management controller 165-a may signal an indication to migrate one or more services (e.g., one or more operations of the host system 105-a and the memory system 110-a). For example, the indication may indicate to migrate services from the host system 105-a to another host system 105, from the memory system 110-a to another memory system 110, from the DIMM slot 265-a to another DIMM slot 265, among other migrations.

Thus, in accordance with these and other examples, an architecture 200 (e.g., a system management controller 165-a) may be configured to poll register(s) 255 of a PMIC 160-a during operations of the host system 105-a. The register(s) 255 may indicate one or more operating parameters of the PMIC 160-a. The system management controller 165-a may perform one or more operations to reduce a thermal characteristic of the PMIC 160-a (e.g., or may signal one or more failure warnings) based on the operating parameters satisfying one or more thresholds. Additionally, or alternatively, an architecture 200 (e.g., a system management controller 165-a) may be configured to poll register(s) 255 in response to a failure at the PMIC 160-a (e.g., indicated by an output of the CAMP 225), and the system management controller 165-a may store a location of the failure at the PMIC 160-a based on the register(s) 255. The system management controller 165-a may also store one or more operation parameters of the PMIC 160-a at the time of failure (e.g., a cause of the failure at the PMIC 160-a), a condition of one or more power rails interfaces associated with the PMIC 160-a at the time of failure, or a combination thereof based on the register(s) 255.

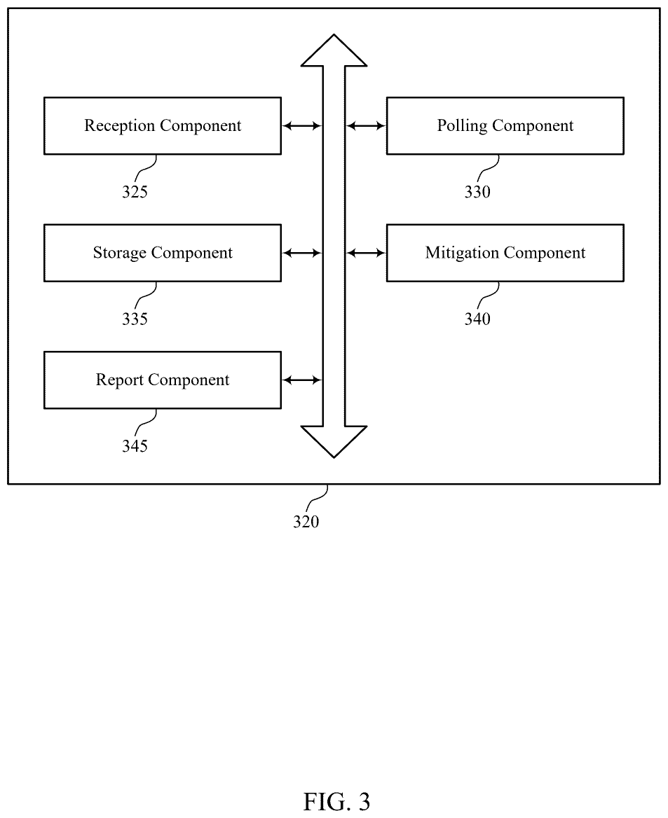

FIG. 3 shows a block diagram of a system management controller 320 (e.g., a system management controller 165-a) that supports memory system power management integrated circuitry monitoring in accordance with examples as disclosed herein. The system management controller 320 may be an example of aspects of a system management controller as described with reference to FIGS. 1 and 2. The system management controller 320, or various components thereof, may be an example of means for performing various aspects of memory system power management integrated circuitry monitoring as described herein. For example, the system management controller 320 may include a reception component 325, a polling component 330, a storage component 335, a mitigation component 340, a report component 345, or any combination thereof. Each of these components, or components of subcomponents thereof (e.g., one or more processors, one or more memories), may communicate, directly or indirectly, with one another (e.g., via one or more buses).

In some examples, the reception component 325 may be configured as or otherwise support a means for receiving an indication of a failure of a PMIC (e.g., a PMIC 160) of a memory system (e.g., a memory system 110), the failure associated with a shutdown condition of the memory system. In some examples, the polling component 330 may be configured as or otherwise support a means for polling, in response to receiving the indication, one or more registers (e.g., register(s) 255) of the PMIC to receive an indication of a location (e.g., a DIMM slot 265-a) of the failure of the PMIC. In some examples, the storage component 335 may be configured as or otherwise support a means for storing the indication of the location of the failure of the PMIC at a storage component (e.g., a storage component 250) of the system management controller.

In some examples, to support the polling, the polling component 330 may be configured as or otherwise support a means for polling the one or more registers of the PMIC while a first voltage source (e.g., a voltage source 260-a) to the PMIC is disabled in response to the failure and a second voltage source (e.g., a voltage source 260-b) to the PMIC remains enabled after the failure.

In some examples, the indication of the failure of the PMIC is associated with a CAMP output (e.g., a CAMP 225) of the PMIC.

In some examples, the CAMP output of the PMIC is associated with a set of multiple DIMM slots, and the location of the failure of the PMIC is associated with one of the set of multiple DIMM slots (e.g., DIMM slots 265).

In some examples, the polling component 330 may be configured as or otherwise support a means for polling, in response to receiving the indication of the failure at the PMIC, one or more second registers of the PMIC to receive a second indication of one or more operating parameters of one or more power interfaces (e.g., voltage sources 260) associated with the PMIC.

In some examples, the polling component 330 may be configured as or otherwise support a means for polling, in response to receiving the indication of the failure at the PMIC, one or more second registers of the PMIC to receive a third indication of one or more operating parameters of the PMIC.

In some examples, the report component 345 may be configured as or otherwise support a means for outputting the stored indication of the location of the failure of the PMIC from the storage component of the system management controller.

In some examples, to support receiving the indication of the failure at the PMIC, the reception component 325 may be configured as or otherwise support a means for receiving the indication from a CPLD (e.g., a CPLD 220) coupled with the memory system and a host processing system (e.g., a host system 105, a processor 125, a host system controller 120).

In some examples, the polling component 330 may be configured as or otherwise support a means for polling, during operations of a host processing system (e.g., a host system 105, a processor 125, a host system controller 120) and one or more memory systems (e.g., one or more memory systems 110) coupled with the system management controller, one or more registers of a PMIC (e.g., a PMIC 160) of the one or more memory systems to receive one or more indications of one or more operating parameters of the PMIC. The mitigation component 340 may be configured as or otherwise support a means for performing one or more operations to reduce a thermal characteristic of the PMIC based on the one or more indications of the one or more operating parameters of the PMIC satisfying one or more thresholds.

In some examples, reducing the thermal characteristic includes reducing a temperature of the PMIC, reducing a current of the PMIC, or a combination thereof.

In some examples, the polling is performed in accordance with a periodic interval during the operations of the host processing system and the one or more memory systems.

In some examples, the one or more operations, the one or more thresholds, or a combination thereof are based on a failure mitigation policy configured at the system management controller.

In some examples, the mitigation component 340 may be configured as or otherwise support a means for updating the one or more operations associated with the failure mitigation policy, the one or more thresholds associated with the failure mitigation policy, or a combination thereof.

In some examples, to support performing the one or more operations, the mitigation component 340 may be configured as or otherwise support a means for increasing a speed of a fan (e.g., a fan 215) coupled with the system management controller based on the indicated one or more operating parameters indicating that a temperature of the PMIC satisfies a threshold.

In some examples, to support performing the one or more operations, the mitigation component 340 may be configured as or otherwise support a means for outputting, to the host processing system, an indication to perform a throttling operation associated with the one or more operations of the host processing system and the one or more memory systems based on the indicated one or more operating parameters indicating that a current or a power associated with the PMIC satisfies a threshold.

In some examples, to support performing the one or more operations, the mitigation component 340 may be configured as or otherwise support a means for outputting an indication to migrate at least one operation of the one or more operations of the host processing system and the one or more memory systems (e.g., to a different memory system 110) based on the indicated one or more operating parameters indicating that a current associated with the PMIC satisfies a threshold.

In some examples, the described functionality of the system management controller 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the system management controller 320, or various components thereof, may be implemented at least in part by instructions (e.g., stored in memory, non-transitory computer-readable medium) executable by such at least one processor.

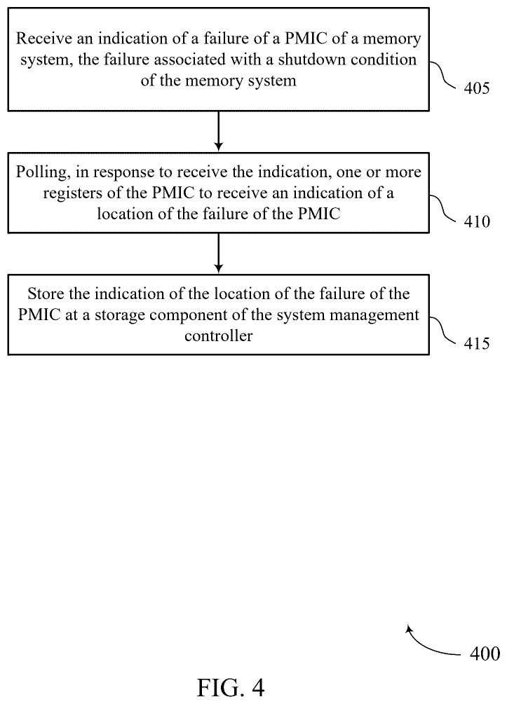

FIG. 4 shows a flowchart illustrating a method 400 that supports memory system power management integrated circuitry monitoring in accordance with examples as disclosed herein. The operations of method 400 may be implemented by a system management controller or its components as described herein. For example, the operations of method 400 may be performed by a system management controller as described with reference to FIGS. 1 through 3. In some examples, a system management controller may execute a set of instructions to control the functional elements of the device to perform the described functions. Additionally, or alternatively, the system management controller may perform aspects of the described functions using special-purpose hardware.

At 405, the method may include receiving an indication of a failure of a PMIC (e.g., a PMIC 160) of a memory system (e.g., a memory system 110), the failure associated with a shutdown condition of the memory system.

At 410, the method may include polling, in response to receiving the indication, one or more registers (e.g., register(s) 255) of the PMIC to receive an indication of a location of the failure of the PMIC.

At 415, the method may include storing the indication of the location of the failure of the PMIC at a storage component (e.g., a storage component 250) of the system management controller.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving an indication of a failure of a PMIC (e.g., a PMIC 160) of a memory system (e.g., a memory system 110), the failure associated with a shutdown condition of the memory system; polling, in response to receiving the indication, one or more registers of the PMIC to receive an indication of a location of the failure of the PMIC; and storing the indication of the location of the failure of the PMIC at a storage component (e.g., a storage component 250) of the system management controller.

Aspect 2: The method, apparatus, or non-transitory computer-readable medium of aspect 1, where the polling includes operations, features, circuitry, logic, means, or instructions, or any combination thereof for polling the one or more registers (e.g., register(s) 255) of the PMIC while a first voltage source (e.g., a voltage source 260-a) to the PMIC is disabled in response to the failure and a second voltage source (e.g., a voltage source 260-b) to the PMIC remains enabled after the failure.

Aspect 3: The method, apparatus, or non-transitory computer-readable medium of any of aspects 1 through 2, where the indication of the failure of the PMIC is associated with a CAMP output (e.g., a CAMP 225) of the PMIC.

Aspect 4: The method, apparatus, or non-transitory computer-readable medium of aspect 3, where the CAMP output of the PMIC is associated with a set of multiple DIMM slots, and the location of the failure of the PMIC is associated with one of the set of multiple DIMM slots (e.g., DIMM slots 265).

Aspect 5: The method, apparatus, or non-transitory computer-readable medium of any of aspects 1 through 4, further including operations, features, circuitry, logic, means, or instructions, or any combination thereof for polling, in response to receiving the indication of the failure at the PMIC, one or more second registers of the PMIC to receive a second indication of one or more operating parameters of one or more power interfaces associated with the PMIC.

Aspect 6: The method, apparatus, or non-transitory computer-readable medium of any of aspects 1 through 5, further including operations, features, circuitry, logic, means, or instructions, or any combination thereof for polling, in response to receiving the indication of the failure at the PMIC, one or more second registers of the PMIC to receive a third indication of one or more operating parameters of the PMIC.

Aspect 7: The method, apparatus, or non-transitory computer-readable medium of any of aspects 1 through 6, further including operations, features, circuitry, logic, means, or instructions, or any combination thereof for outputting the stored indication of the location of the failure of the PMIC from the storage component of the system management controller.

Aspect 8: The method, apparatus, or non-transitory computer-readable medium of any of aspects 1 through 7, where receiving the indication of the failure at the PMIC includes operations, features, circuitry, logic, means, or instructions, or any combination thereof for receiving the indication from a CPLD (e.g., a CPLD 220) coupled with the memory system and a host processing system (e.g., a host system 105, a processor 125, a host system controller 120).

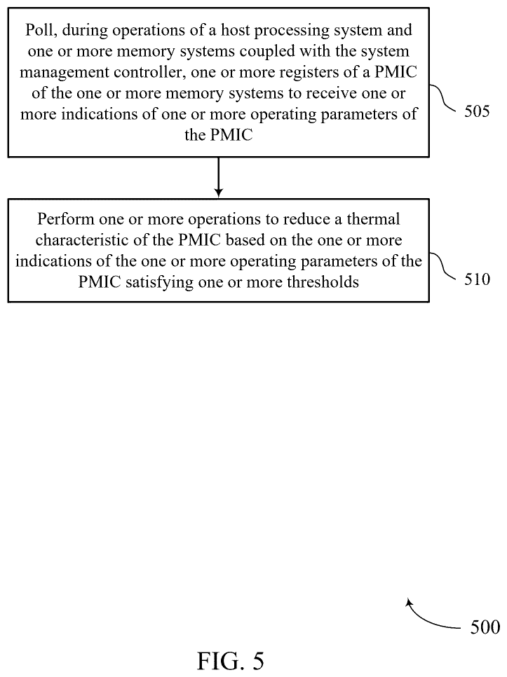

FIG. 5 shows a flowchart illustrating a method 500 that supports memory system power management integrated circuitry monitoring in accordance with examples as disclosed herein. The operations of method 500 may be implemented by a system management controller or its components as described herein. For example, the operations of method 500 may be performed by a system management controller as described with reference to FIGS. 1 through 3. In some examples, a system management controller may execute a set of instructions to control the functional elements of the device to perform the described functions. Additionally, or alternatively, the system management controller may perform aspects of the described functions using special-purpose hardware.

At 505, the method may include polling, during operations of a host processing system (e.g., a host system 105, a processor 125, a host system controller 120) and one or more memory systems (e.g., one or more memory systems 110) coupled with the system management controller, one or more registers of a PMIC (e.g., a PMIC 160) of the one or more memory systems to receive one or more indications of one or more operating parameters of the PMIC.

At 510, the method may include performing one or more operations to reduce a thermal characteristic of the PMIC based on the one or more indications of the one or more operating parameters of the PMIC satisfying one or more thresholds.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 9: A method, apparatus, or non-transitory computer-readable medium including operations, features, circuitry, logic, means, or instructions, or any combination thereof for polling, during operations of a host processing system (e.g., a host system 105, a processor 125, a host system controller 120) and one or more memory systems (e.g., one or more memory systems 110) coupled with the system management controller, one or more registers of a PMIC (e.g., a PMIC 160) of the one or more memory systems to receive one or more indications of one or more operating parameters of the PMIC and performing one or more operations to reduce a thermal characteristic of the PMIC based on the one or more indications of the one or more operating parameters of the PMIC satisfying one or more thresholds.

Aspect 10: The method, apparatus, or non-transitory computer-readable medium of aspect 9, where reducing the thermal characteristic includes reducing a temperature of the PMIC, reducing a current of the PMIC, or a combination thereof.

Aspect 11: The method, apparatus, or non-transitory computer-readable medium of any of aspects 9 through 10, where the polling is performed in accordance with a periodic interval during the operations of the host processing system and the one or more memory systems.

Aspect 12: The method, apparatus, or non-transitory computer-readable medium of any of aspects 9 through 11, where the one or more operations, the one or more thresholds, or a combination thereof are based on a failure mitigation policy configured at the system management controller.

Aspect 13: The method, apparatus, or non-transitory computer-readable medium of aspect 12, further including operations, features, circuitry, logic, means, or instructions, or any combination thereof for updating the one or more operations associated with the failure mitigation policy, the one or more thresholds associated with the failure mitigation policy, or a combination thereof.

Aspect 14: The method, apparatus, or non-transitory computer-readable medium of any of aspects 9 through 13, where performing the one or more operations includes operations, features, circuitry, logic, means, or instructions, or any combination thereof for increasing a speed of a fan coupled with the system management controller based on the indicated one or more operating parameters indicating that a temperature of the PMIC satisfies a threshold.

Aspect 15: The method, apparatus, or non-transitory computer-readable medium of any of aspects 9 through 14, where performing the one or more operations includes operations, features, circuitry, logic, means, or instructions, or any combination thereof for outputting, to the host processing system, an indication to perform a throttling operation associated with the one or more operations of the host processing system and the one or more memory systems based on the indicated one or more operating parameters indicating that a current or a power associated with the PMIC satisfies a threshold.

Aspect 16: The method, apparatus, or non-transitory computer-readable medium of any of aspects 9 through 15, where performing the one or more operations includes operations, features, circuitry, logic, means, or instructions, or any combination thereof for outputting an indication to migrate at least one operation of the one or more operations of the host processing system and the one or more memory systems based on the indicated one or more operating parameters indicating that a current associated with the PMIC satisfies a threshold.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “isolated” may refer to a relationship between components in which signals are not presently capable of flowing between the components. Components are isolated from each other if there is an open circuit between them. For example, two components separated by a switch that is positioned between the components are isolated from each other when the switch is open. When a component isolates two components, the component may initiate a change that prevents signals from flowing between the other components using a conductive path that previously permitted signals to flow.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method by a system management controller, comprising:
receiving an indication of a failure of a power management integrated circuit (PMIC) of a memory system, the failure associated with a shutdown condition of the memory system;
polling, in response to receiving the indication, one or more registers of the PMIC to receive an indication of a location of the failure of the PMIC; and
storing the indication of the location of the failure of the PMIC at a storage component of the system management controller.

2. The method of claim 1, wherein the polling comprises:
polling the one or more registers of the PMIC while a first voltage source to the PMIC is disabled in response to the failure and a second voltage source to the PMIC remains enabled after the failure.

3. The method of claim 1, wherein the indication of the failure of the PMIC is associated with a control and monitor port (CAMP) output of the PMIC.

4. The method of claim 3, wherein the CAMP output of the PMIC is associated with a set of multiple dual in-line memory (DIMM) slots, and the location of the failure of the PMIC is associated with one of the set of multiple DIMM slots.

5. The method of claim 1, further comprising:
polling, in response to receiving the indication of the failure at the PMIC, one or more second registers of the PMIC to receive a second indication of one or more operating parameters of one or more power interfaces associated with the PMIC.

6. The method of claim 1, further comprising:
polling, in response to receiving the indication of the failure at the PMIC, one or more second registers of the PMIC to receive a third indication of one or more operating parameters of the PMIC.

7. The method of claim 1, further comprising:
outputting the stored indication of the location of the failure of the PMIC from the storage component of the system management controller.

8. The method of claim 1, wherein receiving the indication of the failure at the PMIC comprises:
receiving the indication from a complex programmable logic device (CPLD) coupled with the memory system and a host processing system.

9. A method by a system management controller, comprising:
polling, during operations of a host processing system and one or more memory systems coupled with the system management controller, one or more registers of a power management integrated circuit (PMIC) of the one or more memory systems to receive one or more indications of one or more operating parameters of the PMIC; and
performing one or more operations to reduce a thermal characteristic of the PMIC based on the one or more indications of the one or more operating parameters of the PMIC satisfying one or more thresholds.

10. The method of claim 9, wherein reducing the thermal characteristic comprises reducing a temperature of the PMIC, reducing a current of the PMIC, or a combination thereof.

11. The method of claim 9, wherein the polling is performed in accordance with a periodic interval during the operations of the host processing system and the one or more memory systems.

12. The method of claim 9, wherein the one or more operations, the one or more thresholds, or a combination thereof are based on a failure mitigation policy configured at the system management controller.

13. The method of claim 12, further comprising:
updating the one or more operations associated with the failure mitigation policy, the one or more thresholds associated with the failure mitigation policy, or a combination thereof.

14. The method of claim 9, wherein performing the one or more operations comprises:
increasing a speed of a fan coupled with the system management controller based on the indicated one or more operating parameters indicating that a temperature of the PMIC satisfies a threshold.

15. The method of claim 9, wherein performing the one or more operations comprises:
outputting, to the host processing system, an indication to perform a throttling operation associated with the one or more operations of the host processing system and the one or more memory systems based on the indicated one or more operating parameters indicating that a current or a power associated with the PMIC satisfies a threshold.

16. The method of claim 9, wherein performing the one or more operations comprises:
outputting an indication to migrate at least one operation of the one or more operations of the host processing system and the one or more memory systems based on the indicated one or more operating parameters indicating that a current associated with the PMIC satisfies a threshold.

17. A system management controller, comprising:
a storage component; and
processing circuitry coupled with the storage component and operable to couple with one or more memory systems, the processing circuitry configured to cause the system management controller to:
receive an indication of a failure of a power management integrated circuit (PMIC) of a memory system of the one or more memory systems, the failure associated with a shutdown condition of the memory system;
poll, in response to receipt of the indication, one or more registers of the PMIC to receive an indication of a location of the failure of the PMIC; and
store the indication of the location of the failure of the PMIC at the storage component of the system management controller.

18. The system management controller of claim 17, wherein, to poll the one or more registers, the processing circuitry is configured to cause the system management controller to poll the one or more registers of the PMIC while a first voltage source to the PMIC is disabled in response to the failure and a second voltage source to the PMIC remains enabled after the failure.

19. The system management controller of claim 17, wherein the indication of the failure of the PMIC is associated with a control and monitor port (CAMP) output of the PMIC.

20. The system management controller of claim 19, wherein the CAMP output of the PMIC is associated with a set of multiple dual in-line memory (DIMM) slots, and the location of the failure of the PMIC is associated with one of the set of multiple DIMM slots.

21. The system management controller of claim 17, wherein the processing circuitry is further configured to cause the system management controller to:
poll, in response to receipt of the indication of the failure at the PMIC, one or more second registers of the PMIC to receive a second indication of one or more operating parameters of one or more power interfaces associated with the PMIC.

22. The system management controller of claim 17, wherein the processing circuitry is further configured to cause the system management controller to:
poll, in response to receipt of the indication of the failure at the PMIC, one or more second registers of the PMIC to receive a third indication of one or more operating parameters of the PMIC.

23. A system management controller, comprising:
processing circuitry operable to couple with a host processing system and one or more memory systems, the processing circuitry configured to cause the system management controller to:
poll, in accordance with a periodicity during operations of the host processing system and the one or more memory systems, one or more registers of a power management integrated circuit (PMIC) of the one or more memory systems to receive one or more indications of one or more operating parameters of the PMIC; and
perform one or more operations to reduce a thermal characteristic associated with the PMIC based on the one or more indications of the one or more operating parameters of the PMIC satisfying one or more thresholds.

24. The system management controller of claim 23, wherein reducing the thermal characteristic comprises reducing a temperature of the PMIC, reducing a current of the PMIC, or a combination thereof.

25. The system management controller of claim 23, wherein the polling is performed in accordance with a periodic interval during the operations of the host processing system and the one or more memory systems.
